(19) United States
(12) Patent Application Publication
(10) Pub. No.: US 2026/0101840 A1
(43) Pub. Date: Apr. 16, 2026

(54) HEIGHT ADJUSTMENT SYSTEMS FOR MOWERS

(71) Applicant: TRIMAX MOWING SYSTEMS NZ LIMITED, Tauranga (NZ)

(72) Inventors: Daniel DE RENZY, Tauranga (NZ); Waldo DE VILLIERS, Tauranga (NZ)

(21) Appl. No.: 19/114,517

(22) PCT Filed: Sep. 27, 2023
(86) PCT No.: PCT/NZ2023/050102

§ 371 Date: Mar. 24, 2025

(30) Foreign Application Priority Data
Sep. 27, 2022 (NZ) 792825

(51) Int. Cl. A01D 34/74; A01D 34/00; A01D 69/06; A01D 101/00

(52) U.S. Cl. CPC A01D 34/74; A01D 34/006; A01D 69/06; A01D 2101/00

(57) ABSTRACT

The present technology relates to a mower. The mower may comprise a mowing deck which comprises cutting elements configured to cut plant material, and a support structure to support the mowing deck at a height above a surface. The support structure comprises a first and second side channels, and comprises a height adjustment mechanism to allow for the adjustment of the height of the mowing deck relative to the surface, by moving the mowing deck relative to the side channels. The height adjustment mechanism comprises at least one cam in each side channel, the cams configured to act on the mowing deck to move the mowing deck relative to the side channels. The mower may comprise front and rear rollers. The height adjustment mechanism may adjust the height of the mowing deck relative to the support structure while maintaining a constant distance between the front and rear rollers.

### FIELD OF THE TECHNOLOGY

The present technology relates to height adjustment systems for mowers and components thereof. The present technology may find particular application with mowers for cutting grass.

### BACKGROUND TO THE TECHNOLOGY

Mowers are commonly used to cut and maintain the height of vegetation such as grass. While push-mowers and ride-on style mowers are commonly used to maintain small areas of grass such as lawns, the limited span of their cutting blades means they quickly become inefficient to use on large properties such as turf farms, golf courses, sports fields, parks and the like.

There is therefore a need to provide large mowers which can be used in applications where smaller mowers are not practical. These may be commonly referred to as gang mowers, turf mowers, commercial mowers, or pull behind mowers such as those which are configured to releasably attach to tractors, or other types of prime movers.

These commercial mowers include cutting deck(s) that are designed to cover a much larger area in a single pass and may include multiple decks to further extend the width of the cut. The height of the cutting deck relative to the ground determines the final length of the grass once it has been cut.

For push-mowers and ride-on style mowers, the cutting deck is relatively small, and mechanisms to adjust the cutting deck height can be relatively straightforward. For example, the height of the cutting deck may be raised or lowered by a lever mechanism commonly referred to as a height-of-cut lever. These levers are manually moved by user effort and placed into predefined notches which correspond to a limited range of cut height positions. These mechanisms are not suitable for use in large, pull-behind style mowers where the mowing deck is much larger and heavier, and subject to greater forces in use.

Some commercial mowers use manually operated height adjustment mechanisms which act on opposing corners of the deck individually. These systems can be time-consuming to use and can be difficult to ensure a level cutting height.

Other height adjustment mechanisms can be configured to adjust the height of the cutting deck by adjusting the relative positioning of the support wheels or rollers. However, this can affect the ability of the mower to effectively discharge the cut grass.

### OBJECT OF THE TECHNOLOGY

It is an object of the present technology to provide a mower deck height adjustment mechanism which is fast, easy to use, and/or reliable.

Alternatively, it is an object of the present technology to provide a mower with a cutting height adjustment mechanism that has a single adjustment point.

Alternatively, it is an object of the present technology to provide a mower blade adjustment mechanism, for example a mower deck height adjustment mechanism which has a first adjustment point configured to adjust the height of a first side of the deck of the mower and a second adjustment point to adjust the height of a second side of the deck of the mower.

Alternatively, it is an object of the present technology to provide an electronically controllable mower deck height adjustment system.

Alternatively, it is an object of the present technology to provide a system for adjusting the position of side channels relative to a mower deck of a mower while keeping the orientation of said side channels substantially constant.

Alternatively, it is an object of the present technology to provide a system for adjusting the support structure of a mower, including side channels relative to the deck.

Alternatively, it is an object of the present technology to provide a mower comprising an improved deck height adjustment mechanism.

Alternatively, it is an object of the present technology to provide a deck height adjustment mechanism suitable for use with commercial mowers.

Alternatively, it is an object of the technology to address the foregoing problems and/or to at least provide the public with a useful choice.

### SUMMARY OF THE TECHNOLOGY

According to certain aspects of the invention, there is provided a mower in which a height of cutting elements is able to be adjusted. In some forms, the cutting elements may be mounted to, or form part of, a mowing deck and adjustment of the height of the cutting elements may be achieved through adjustment of the height of the mowing deck.

According to a first aspect of the technology, there is provided a mower, comprising:
a mowing deck which comprises cutting elements configured to cut plant material, and
a support structure configured to support the mowing deck at a height above a surface, wherein the support structure comprises a first side channel and a second side channel, and the support structure comprises a height adjustment mechanism configured to allow for the adjustment of the height of the mowing deck relative to the surface, by moving the mowing deck relative to the side channels, and
wherein the height adjustment mechanism comprises at least one cam in each side channel, wherein the cams are configured to act on the mowing deck to move the mowing deck relative to the side channels.

According to another aspect of the technology, there is provided a mower, comprising:
a mowing deck which comprises cutting elements configured to cut plant material, and
a support structure configured to support the mowing deck at a height above a surface, wherein the support structure comprises a first side channel, a second side channel, at least one front roller, and at least one rear roller, the at least one front roller being positioned between the first side channel and the second side channel substantially on a front side of the support structure, and the at least one rear roller being positioned between the first side channel and the second side channel substantially on a rear side of the support structure,
wherein the support structure comprises a height adjustment mechanism configured to adjust the height of the mowing deck relative to the support structure while maintaining a constant distance between the at least one front roller and the at least one rear roller.

According to another aspect of the technology, there is provided a mower, comprising:
a mowing deck which comprises cutting elements configured to cut plant material,
a support structure configured to support the mowing deck at a height above a surface, and
a height adjustment system,
wherein the support structure comprises at least one side channel, and
wherein the height adjustment system comprises a drive means configured to provide a rotational force, and wherein the at least one side channel comprises a series of rotating elements configured to transfer rotational movement from the drive means to at least one cam, the at least one cam being rotatably connected to the at least one side channel, and operatively connected to the mowing deck, such that rotation of the cam causes the height of the mowing deck to change.

In one example, the orientation of the mowing deck with respect to the support structure may remain substantially constant as the height adjustment system changes the height of the mowing deck with respect to the surface.

In examples, the support structure may comprise a plurality of side channels. For example, the side channels may be positioned at opposing sides of the mowing deck, substantially parallel to each other. In some examples it may be advantageous for the side channels to be oriented substantially parallel to the forwards and backwards movement direction of the mower in use.

In examples comprising a plurality of side channels, the drive means may be operatively connected to each of the plurality of side channels such that actuation of the drive means results in the height of the deck relative to the surface being adjusted relative to both side channels of the mower simultaneously.

In examples each of the plurality of side channels may comprise a series of rotating elements configured to transfer rotational movement from the drive means to at least one cam rotatably connected to each side channel. For example, each side channel may comprise at least two cams, each of the cams being rotatably connected to the side channels and operatively connected to the deck.

In examples, the rotating elements may comprise any one or more of gears, belts, chains and/or pulleys. In one example the rotating elements comprise a gear assembly which comprises a plurality of gears. For example, the gear assembly may comprise at least one compound gear.

In examples, the gear assembly may be configured to provide a gear reduction. The gear reduction may have a relatively high ration, for example the gear assembly may provide a gear ratio of between substantially 1:20 and 1:40 such as substantially 1:30.

In examples, the gear assembly may comprise a plurality of gears oriented with an axis of rotation which is substantially horizontal, or substantially parallel to the surface or ground.

In examples the gear assembly may comprise a plurality of gears positioned within a first plane, and a plurality of gears positioned within a second plane, the first plane being parallel and offset to the second plane.

In examples the gear assembly may comprise a plurality of gears oriented substantially relatively vertically. For example, two or more of the gears may be positioned above one another, such as directly above one another.

In examples the gear assembly may comprise a plurality of gears oriented substantially relatively horizontally, or adjacent in a direction substantially parallel to the surface. For example, two or more of the gears may be positioned next to one another in a horizontal axis.

In examples the gear assembly may be substantially symmetrical. For example, the gear assembly may have at least one axis of symmetry.

In examples, one or more of the gears of the gear assembly may be attached to one or more cams, configured to act upon the deck in use to adjust the height of the deck relative to the side channels.

In examples, the gear assembly is configured to rotate a plurality of cams at the same speed.

In examples, the mower may comprise a plurality of drive means. For example, the mower may comprise one drive means on each side of the mowing deck. In other examples the mower may comprise a single drive means.

In examples the drive means may comprise any one or more of: a motor, such as an electric motor or combustion engine, a hydraulic or pneumatic system, one or more batteries, or a coupler configured to connect to a drive source, such as the PTO (Power Take Off) on a tractor or prime mover.

In examples the drive means may comprise a worm gearbox.

In examples, the mower may comprise a plurality of decks and a plurality of support structures. For example, the mower may comprise one support structure for each of the plurality of decks. In some examples the mower may comprise between two and five decks and/or support structures, such as three decks and/or support structures.

In examples, the height adjustment mechanism may be configured to move the mowing deck through an arcuate path of movement between a first raised position and a second lowered position. For example, the path of the arcuate movement may be substantially defined by at least one cam.

In an alternative example, the cutting height adjustment mechanism may be configured to move the mowing deck through a substantially linear path of movement between the first position and the second position. For example, this linear path of movement may be less than 90 degrees relative to a horizontal plane, or ground/surface on which the mower is positioned, such as between substantially 45 and substantially 85 degrees, between substantially 65 and substantially 75 degrees or substantially 70 degrees.

In examples of the technology, the mower may be a self-propelled autonomous mower, while in other examples the mower may be a mower attachment configured to be moved by a vehicle such as a tractor or other prime mover.

In examples, the cutting elements may comprise at least one rotary mowing blade.

In examples, the cutting elements are rotary mower blades. However alternative cutting elements such as reel mowers, shear mowers, flails, lasers, or any other cutting elements known to those skilled in the art are within the scope of the present technology.

It should be appreciated that the cutting blades may be reel or cylinder blades, standard/straight/deck blades, mulching blades, lifting blades, or any other type of blade known to those skilled in the art.

In examples, the deck may include a plurality of cutting elements. Inclusion of a plurality of cutting assemblies may allow the mower to mow a wider strip of crops/vegetation/grass in a single pass.

In examples, the cutting elements may be configured to rotate about a substantially vertical axis, or an axis which is substantially perpendicular to the surface/ground. In an alternative form, the cutting elements may be configured to rotate about a substantially horizontal axis or an axis which is substantially parallel with the surface/ground.

In examples, the mower may include at least one skid. For example, the mower may comprise a skid attached to the underside of each of the side channels. In examples the skid may be attached to the side channels using at least one resiliently deformable member such as a spring.

In examples, the mower may include at least one roller or wheel. For example, the mower may include a two or more rollers extending between the side channels of the support structure, in a direction which is substantially perpendicular to a longitudinal axis of the side channels. In other examples, the mower may comprise a plurality of wheels positioned between the side channels of the support structure.

According to a yet further aspect of the technology there is provided components of a cutting height adjustment mechanism substantially as described herein.

According to a yet further aspect of the technology there is provided a method of adjusting the cutting height of a mower the mower substantially as described above, wherein the method includes the following step:
a) engaging the adjustment mechanism to adjust the height of the mowing deck relative to the surface.

Reference is made throughout the present specification to the mower being used to cut plant material on a surface. It will be appreciated by those skilled in the art that the present technology may be applicable to applications such as cutting grass, crop harvesting and weed control. Furthermore, the present technology may be used in other applications which do not use cutting assemblies, for example, harrows, seeders, sprayers and so forth.

Furthermore, it will be appreciated that the height adjustment mechanisms and mechanisms of the present technology may find particular application in commercial mowers. Commercial mowers should be understood to mean large scale mowers, such as those typically used on turf farms, golf courses, sports fields, parks and the like. These mowers are typically tractor powered or are mowing attachments configured to attach to a tractor. However, the term commercial mowers also includes autonomous or remotely controlled mowers. It should be understood that the term “commercial mowers” generally excludes walk behind, push mowers or ride-on style mowers which are commonly used residential properties and lifestyle blocks.

Commercial mowers may also comprise more than one deck. It will be understood that the cutting height adjustment mechanism of the present technology may be provided to one or more of the decks of the mower.

Throughout the present specification, use of the term “deck” should be understood to mean a housing which contains a least one cutting system.

Throughout the present specification, reference will be made to maintaining the orientation of a lateral side of the deck/support structure/side channel as the height is adjusted between a first and a second position. This should be interpreted as meaning that the lateral side of the deck/support structure/side channel undergoes a translational movement as opposed to a pivotal motion. The term ‘translational movement’ should be understood to mean movement in which each part of the object being moved follows the same path, i.e., the object is moved without pivoting or rotating. In other words, in the preferred form of the technology each end of the support structure/side channel(s) moves simultaneously and travels substantially the same distance relative to the deck.

It should also be appreciated that movement of the side channel relative to the deck means that the side channels may remain substantially stationary while the deck is moved in position. This may occur when the side channels, rollers or other transport system are resting on the ground as the adjustment mechanism is operated. Furthermore, the side channel when in the first position is equivalent to the deck being in the second position and vice versa.

In examples, the mower may be configured to attach to a prime mover.

A “prime mover” should be understood to be a working vehicle with an onboard internal combustion or electric motor with a hitch to which a mower may be mounted. Examples of such prime movers include tractors, all-terrain vehicles (ATVs), trucks, and utility vehicles. Reference shall now be made throughout the remainder of the specification to the prime mover being a tractor although this is not meant to be limiting.

In examples, the mower may be configured to attach to the front, rear, or sides of a vehicle, such as a tractor. For example, the mower may be releasably attachable to the vehicle.

In examples, the mower may comprise electrical or control connections configured to allow for control of the mower from the vehicle, such as adjusting the height of the deck relative to the surface from within the vehicle. In some examples, operation of the mower may be effected wirelessly.

In examples, the deck may provide a cover over the cutting elements, so as to provide a safety barrier preventing objects from being thrown by the cutting system towards the operator of the mower. The cover may provide further safety by limiting exposure to the cutting elements.

It should be appreciated from the foregoing discussion that the present technology may provide any one or more of the following advantages:
a cutting height adjustment mechanism for a mower which is easy to use;
a cutting height adjustment mechanism which is quick to operate;
a cutting height adjustment mechanism that requires less corner-to-corner adjustment to achieve an even cut;
a cutting height adjustment mechanism operable with a single action or dual action. In other words, an operator may engage a single adjustment point to adjust the height of the deck or engage a first adjustment point on a first side of the mower and a second adjustment point on a second side of the mower to adjust the cutting height;
a cutting height adjustment mechanism that allows a wide range of cutting heights; and
a cutting height adjustment mechanism which is more resilient to forces imparted from travelling over undulating ground
a cutting height adjustment system which provides a fixed spacing between the wheels and/or rollers.

Further aspects of the technology, which should be considered in all its novel aspects, will become apparent to those skilled in the art upon reading of the following description which provides at least one example of a practical application of the technology.

### BRIEF DESCRIPTION OF THE DRAWINGS

One or more embodiments of the technology will be described below by way of example only, and without intending to be limiting, with reference to the following drawings, in which:

FIG. 1A shows a side view of a mower with a deck in a first position relative to a support structure according to a first embodiment of the present technology;

FIG. 1B shows a side view of the mower of FIG. 1B with the deck in a second position relative to the support structure;

FIG. 1C shows a side view of the mower of FIGS. 1A and 1B with the deck in an intermediate position relative to the support structure, the intermediate position between the first and second positions;

FIG. 1D shows a second side view of the mower of FIGS. 1A, 1B and 1C;

FIG. 2A shows a perspective view of a rail slide mechanism and deck height gauge according to an embodiment of the present technology;

FIG. 2B shows a partial cross-section of the slide mechanism of FIG. 2A taken through the cross-sectional lines marked A-A on FIG. 2A;

FIG. 3A shows a side view of a mower with a deck in a first position relative to a support structure according to a further embodiment of the present technology;

FIG. 3B shows a side view of the mower of FIG. 3A with the deck in a second position relative to the support structure;

FIG. 4A shows a perspective view of the adjustment mechanism of the embodiments of FIGS. 3A and 3B;

FIG. 4B shows a top-down cross section view of the adjustment mechanism of FIG. 4A taken through the cross-sectional lines marked B-B on FIG. 4A;

FIG. 4C shows a side view of a mower using a hydraulic drive means as a component of height adjustment system;

FIG. 5A shows a perspective view of a support structure in accordance with one embodiment of the present technology;

FIG. 5B shows a top-down view of the support structure of FIG. 5A;

FIG. 5C shows a side view of the support structure of FIGS. 5A and 5B;

FIG. 5D shows a first perspective view of a side channel of the support structure of FIGS. 5A to 5C;

FIG. 5E shows a second perspective view of a side channel of FIG. 5D;

FIG. 5F shows a side view of the support structure of FIGS. 5A to 5C with the cover removed;

FIG. 6 shows a perspective view of a mower according to the present technology.

### DETAILED DESCRIPTION OF EXEMPLARY FORMS OF THE TECHNOLOGY

### Overview of the Technology

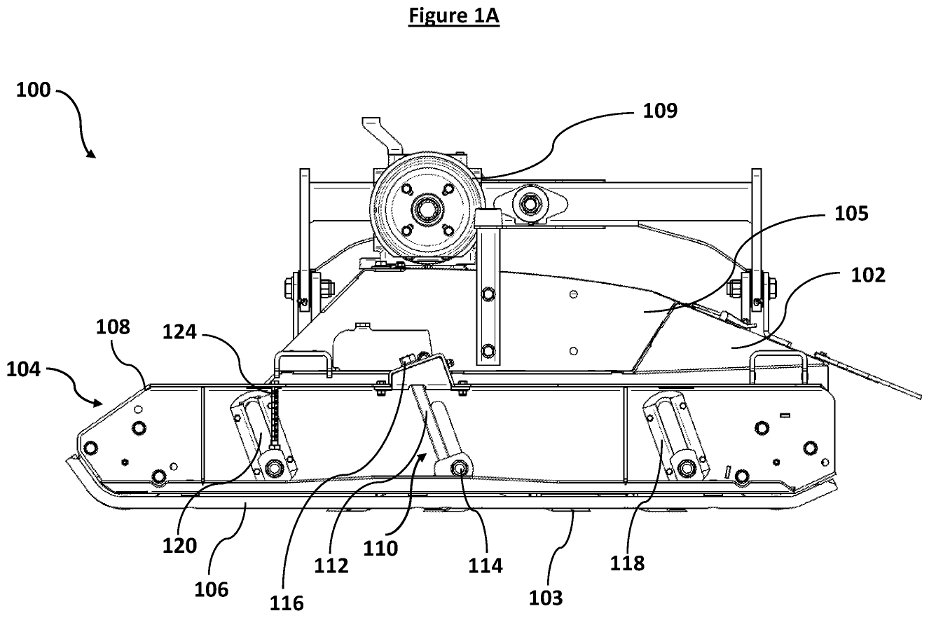

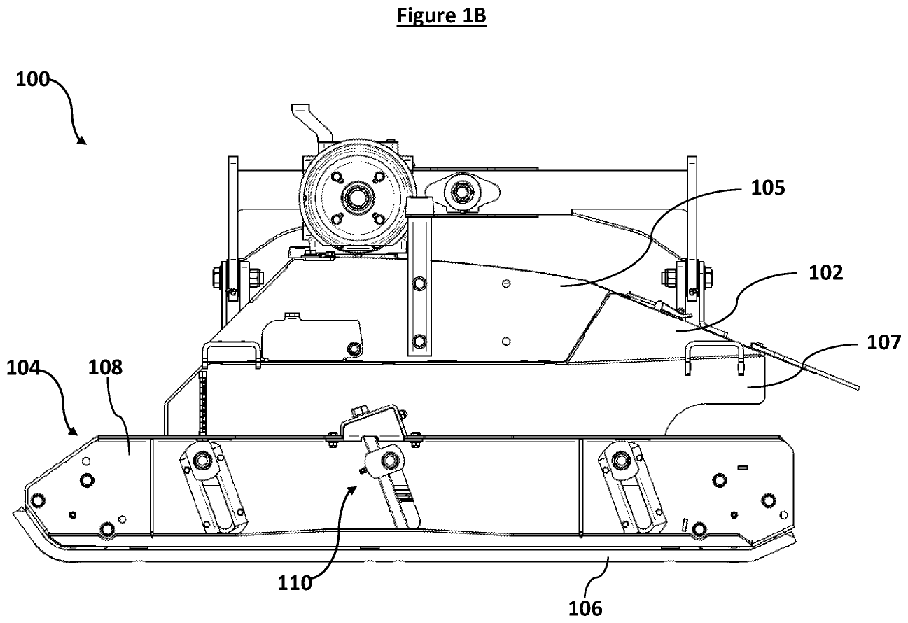

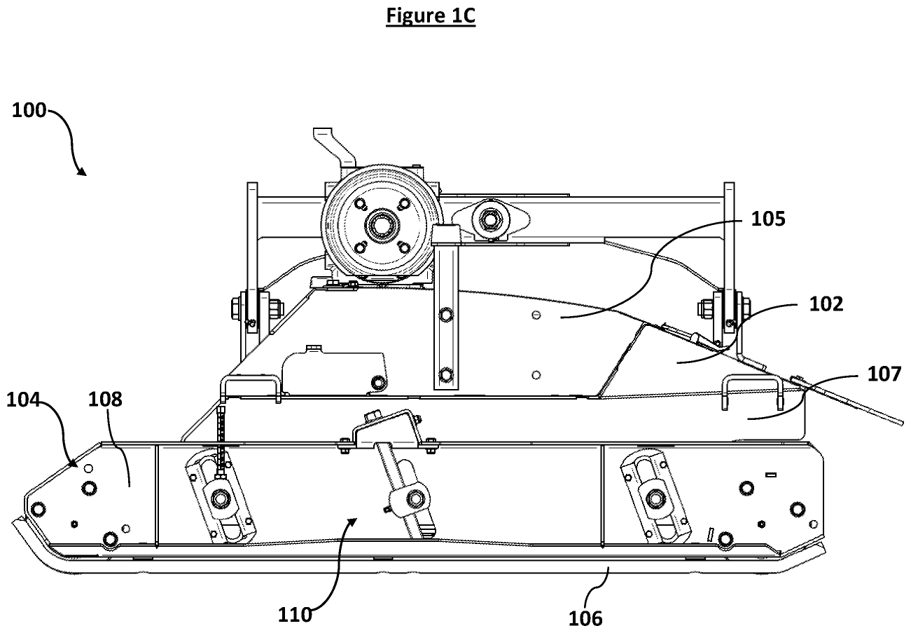

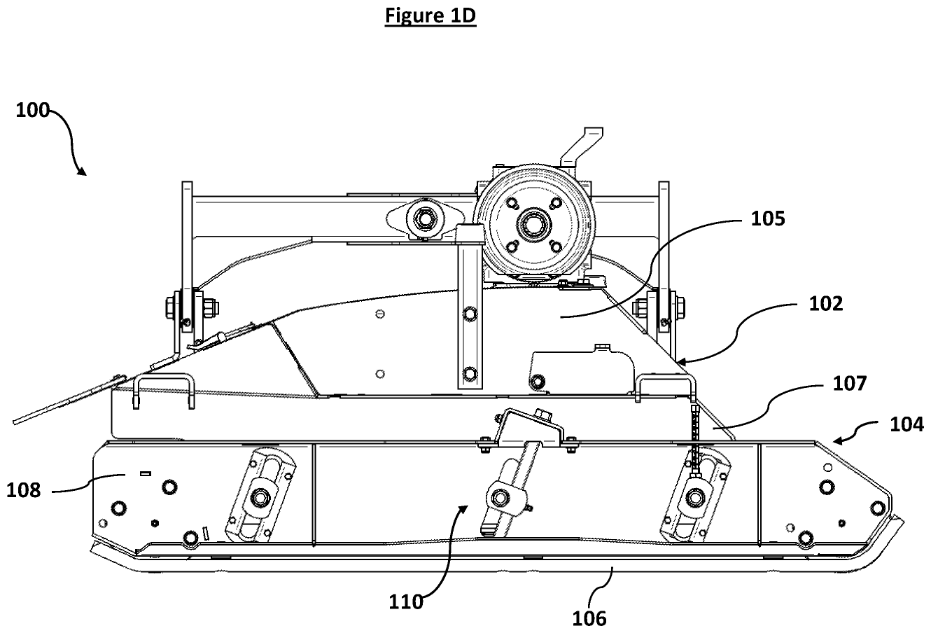

The present technology relates to commercial mowers 100 used in the cutting of grass and other vegetation. With reference to FIGS. 1A to 1D, commercial mowers generally include a deck 102 which includes at least one cutting system 103 such as rotary blades which should be familiar to those skilled in the art. The height of the deck 102 and associated cutting system above the ground defines the cutting height of the mower 100.

In examples described herein, the deck 102 is supported by a support structure 104, which generally includes a pair of side channels 108 on opposite sides of the deck 102. The purpose of the support structure 104 is to maintain the deck 102 and cutting system 103 at a substantially constant height above the ground when cutting vegetation in order to provide an even cut. Systems and methods described herein expand on this by allowing for adjustment of the height of the deck 102 above the ground in order to provide for a range of grass cut heights.

The foregoing technologies and examples primarily relate to systems components and devices for the adjustment of the height of the cutting deck 102 relative to the ground. However commercial mowers can be provided with many different permutations, and features which are generally unrelated to the height adjustment systems described herein. This includes for example, the specific cutting systems, wheels, rollers, number of decks, power sources etc. Accordingly, these components are described by way of example only, and may be used interchangeably as required.

### Deck and Cutting System

The term deck 102 or cutting deck should be familiar to those skilled in the art, but for sake of clarity, the deck 102 should be understood to including a housing which contains one of more cutting systems or elements 103. The housing generally includes a top cover 105 which protects the cutting system/elements as well as prevents people from inadvertently contacting the cutting elements 103 in use.

In some examples the housing may include side walls 107 (best shown in FIG. 1B), which substantially extend downwardly (towards the ground) from either side of the top cover 105 to provide a U-shaped housing which contains the cutting system.

The side walls 107 may attach to the support structure 104 for example using a height adjustment mechanism as described herein. For example, the side walls 107 may be adjustably attached to one or more side channels, so that the position of the deck 102 may be adjusted with respect to the support structure 104 in order to vary the cutting height above the ground.

The housing of the deck 102 may generally have an exposed front, through which the grass or vegetation to be cut passes in use. In examples the deck may also have an exposed rear section which can aid in the discharge of the cut grass/vegetation.

The cutting system 103 may be selected depending on the intended application of the mower. For example, the cutting system 103 may comprise cutting elements such as blades, reel mowers, shear mowers, flails, lasers, or any other cutting elements known to those skilled in the art.

In some examples of the technology, the deck 102 can be configured to support a drive means 109 which in use drives the cutting system. For example, the drive means 109 could include any one or more of a motor, such as an electric or diesel/petrol motor, a hydraulic or pneumatic system, or be configured to connect to a drive source, such as the PTO (Power Take Off) on a tractor or prime mover as should be familiar to those skilled in the art. In some forms, the drive means 109 may be powered by a battery. The battery may be configured to be charged from power generated by the vehicle's motor.

### Support Structure

In the examples described herein, the deck 102 is supported by a support structure 104 which comprises a plurality of side channels 108, such as a first side channel 108 located on a first lateral side of the deck 102, and a second side channel 108 located on a second lateral side of the deck 102. The first side channel, and the second side channel may be oriented substantially parallel to one another and relative to the forwards or reverse direction of the mower in use.

In some examples the support structure can include skids 106. Skids 106 are optional components which can be configured to prevent contact between the side channels 108, and the ground, particularly when the mower travels over undulating ground. For example, the skids 106 can be attached to the underside or ground-facing side of the side channels 108. In some examples the skids 106 may be attached using resiliently deformable elements, such as springs to provide some cushioning of the impact which could otherwise be transferred to the mower. As the skids are subject to more frequent impacts during use, these components may be designed to be easily removed and replaced as they become damaged, i.e., the skids may be removably connected to the side channels.

The skid(s) may include at least one upturned end portion. The inclusion of an upturned end portion may reduce the likelihood of the skid(s) catching on or digging into raised portions of ground. The upturned end portion may be provided with a 30-45 degree angle from a horizontal plane in some forms, although the angle may differ in other forms of the technology.

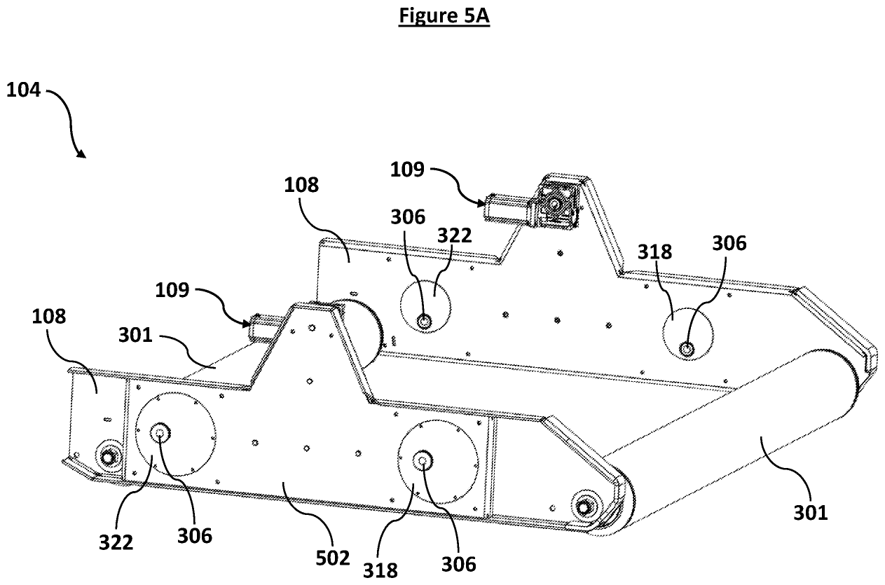

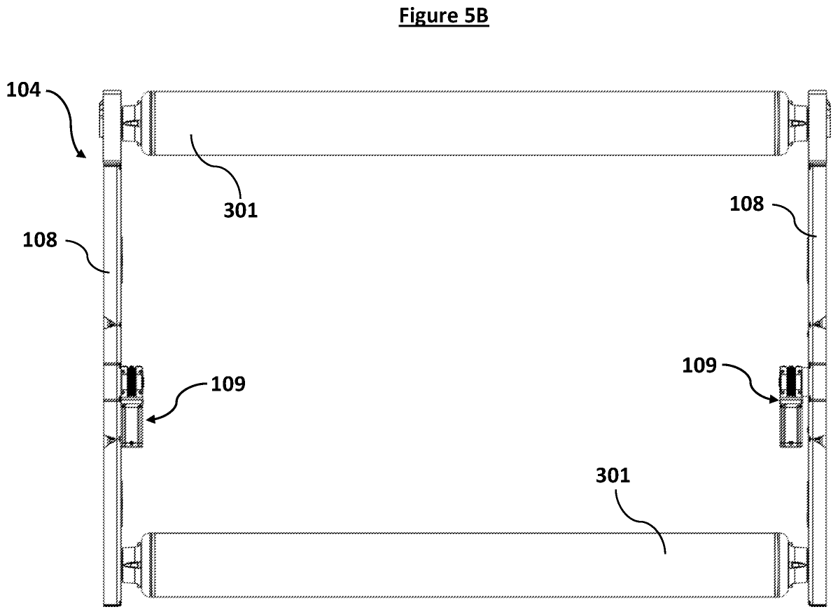

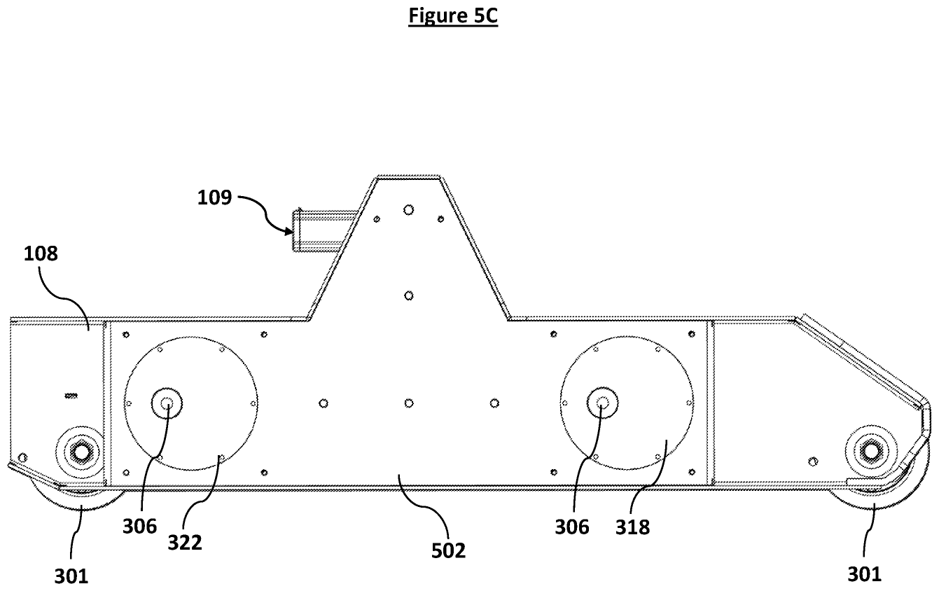

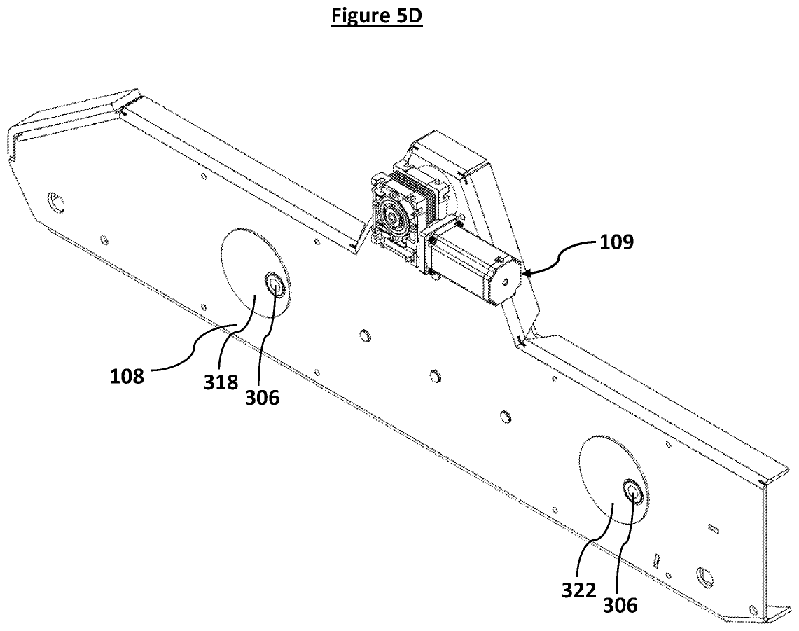

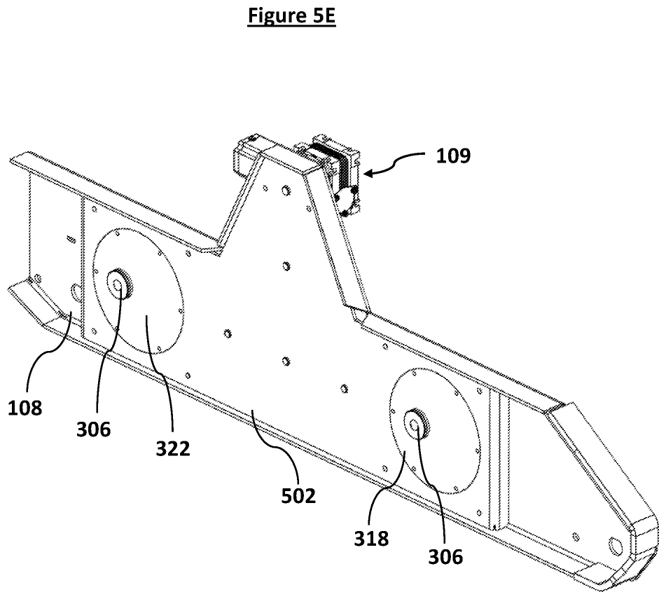

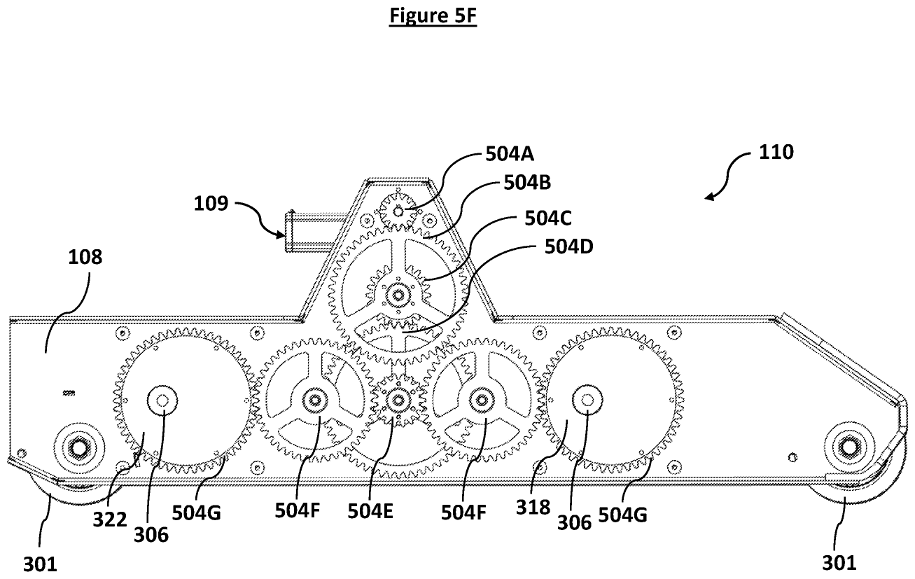

The support structure 104 may also include wheels or rollers 301 (best shown in FIGS. 5A and 5B) which are generally positioned between the side channels 108, in front of, and/or behind the deck 102. These wheels or rollers allow the mower to move along the ground and also raise the side channels of the support structure up, away from the ground such that the side channels or skids do not contact the ground under normal operation, i.e., when moving across substantially flat or rolling terrain. For example, where rollers 301 are used, a first roller 301 may be positioned substantially toward a first end of the mower 100 and be configured to extend between a first side channel 108, and a second side channel 108, in a direction substantially perpendicular to the longitudinal axis of the side channels 108.

In some examples of the technology, a second roller may be positioned substantially toward a second end of the mower 100 and be configured to extend between a first side channel 108, and a second side channel 108, in a direction substantially perpendicular to the longitudinal axis of the side channels 108.

### Height Adjustment Mechanisms

### Linear Height Adjustment

FIGS. 1A to 1D show a first embodiment of a mower 100 according to one aspect of the present technology. The mower includes a deck 102 with at least one cutting system 103 and a support structure 104 configured to support the deck 102 at a height above the ground. In FIG. 1A, the side channels 108 are in a first position relative to the deck 102. This first position corresponds to the deck 102 and associated cutting system being in a lowered position relative to the ground. This therefore corresponds to a low grass cut height.

In FIG. 1B, the mower 100 is shown with the side channel 108 in a second position relative to the deck 102. This second position corresponds to a raised deck 102 position and a high grass cut height. This position may be desirable for transporting the mower 100 across particularly rough or undulating terrain as it may provide a measure of protection against the cutting system 103 contacting the ground.

FIG. 1C shows the mower 100 in an intermediate position wherein the side channels are in a third position relative to the deck 102, the third position being approximately halfway between the first and second positions of FIGS. 1A and 1B respectively.

In some forms, the present technology may permit the deck 102 to be positioned in a continuous non-discrete number of adjustment heights. This may be advantageous over height adjustment systems of the prior art where predefined notches or height adjustment positions are provided. In other forms, the present technology may permit the deck 102 to be positioned in a discrete number of adjustable height positions.

The side channels 108 may be movably attached to the deck 102 by a cutting height adjustment mechanism 110. In the example of FIGS. 1A to 1C, the adjustment mechanism 110 is configured to allow for deck 102 height adjustment relative to the support structure. In the illustrated example, the adjustment mechanism 110 comprises: a threaded actuator 112 and an adjuster block 114. The threaded actuator engages with a complementary threaded aperture in the adjuster block 114, such that rotation of the threaded actuator causes translational movement of the adjuster block 114 relative to the threaded actuator 112. In the illustrated examples, the adjuster block is fixed to the deck 102 of the mower 100 while the threaded actuator is attached to the side channel, such that rotational movement of the threaded actuator relative to the side channel is possible, but translational movement is otherwise restricted. Accordingly, rotation of the threaded actuator 112, causes the adjuster block to move relative to the threaded actuator, enabling the height of the deck to be adjusted relative side channel/support structure.

The direction of movement of the deck relative to the side channels is defined using rail slides 118, through which the adjuster block 114 travels in use. The rail slides 118 guide the movement path of the deck 102 relative to the side channels, thereby ensuring that the relative orientation side channels and deck 102 remains unchanged during height adjustment, i.e., the rail slides 118 ensure translational movement of the deck 102 relative to the side channels 108, rather than end to end adjustment or pivoting movement which may result in undesirable, un-even cutting of the grass.

In some forms of the technology, the adjustment mechanism 110 further includes an adjustment head 116 which is attached to the threaded actuator 112. In the embodiment illustrated, the adjustment head is hexagonal, making it suitable for adjustment using a spanner. The depiction of a hexagonal head however should not be seen as limiting on the technology and as a person skilled in the art will appreciate, other adjustment mechanisms may be used. For example, the adjustment head may include a slot, socket, or recess for a screwdriver, hex-key or similar tools. Alternatively, or additionally, the exterior surface of the head may have a polygonal shape, such as a square or hexagon, suitable for adjustment using a spanner, wrench or pliers etcetera. In an alternative embodiment, the adjustment head may include a handle, textured outer surface, or a large cap to allow for tool-less rotation of the threaded actuator.

Rotation of the adjustment mechanism 112 may be done manually, such as by hand or by using a tool such as a spanner. Alternatively, rotation of the adjustment mechanism may be performed by a powered drive means 109, such as an electronic, pneumatic, or hydraulic system. Furthermore, these adjustment mechanisms may be activated remotely as part of an automated integrated system. Examples of suitable powered drive means are described herein.

It should be appreciated that features described herein are in relation to one side of a mower, and the corresponding features may also be provided to the second side of the mower as illustrated in FIG. 1D. Each side of the mover may be height adjusted independently, or by using any one or more of the linked adjustment mechanisms 110 described herein.

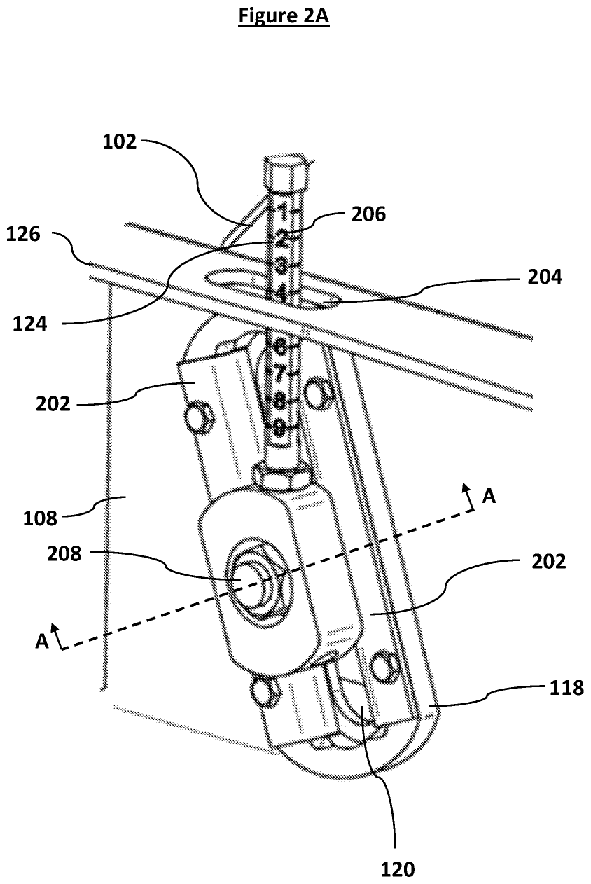

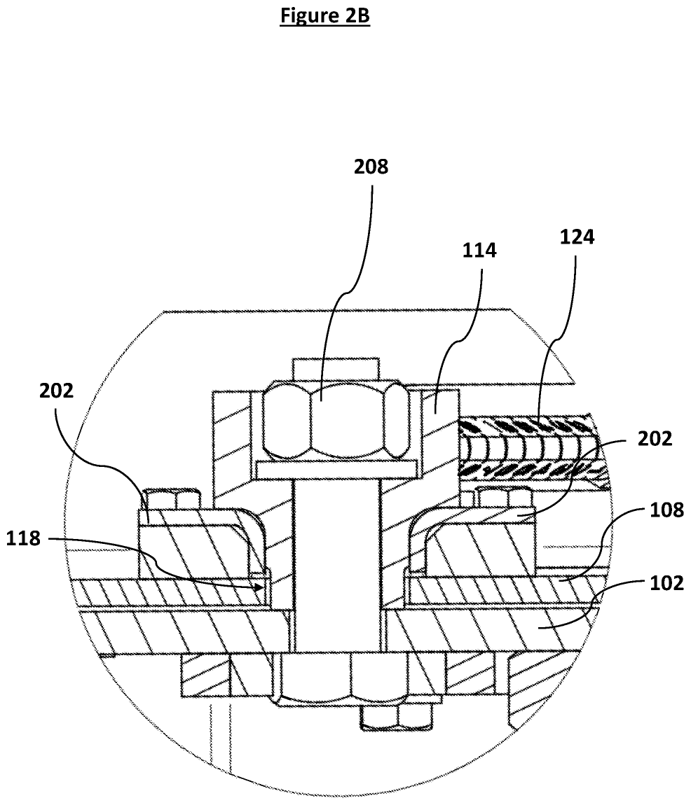

FIG. 2A provides a close-up perspective view of the adjustment mechanism 110 of FIGS. 1A to 1D. In this example, the adjuster block 114 is configured to slide along the channel defined by the rail slide 118 and aperture 120 as the deck 102 moves relative to the side channel 108. An optional addition to the design is the inclusion of wear plates 202. The wear plates 202 may be positioned around the aperture 120, so as to prevent the aperture in the side channels from wearing down over time. The wear plates 202 may be constructed of a durable material such as a metal or a polymer and may protect the rail slide from damage. These wear plates are designed to be easily replaced as required.

A clamping means 208 attaches the adjuster block 114 to the deck 102 as shown in FIG. 2B. The clamping means ensures that the adjuster block travels within the confines of the rail slide 118 in use.

The rail slides 118 and corresponding aperture 120 may be oriented at an angle with respect to the longitudinal axis of the side channel 108. It may be preferable that the rail slides and apertures be oriented at a substantially acute angle relative to the longitudinal axis of the side channel. Use of an acute angle may provide advantages such as more precise height adjustment; easier access to the adjustment mechanism 112; greater end to end stability; and a reduction in the forces imparted to the adjustment mechanism by undulating ground. It will be appreciated however, that in alternative embodiments of the technology, the rail slides and apertures may be oriented at a non-acute angle relative to the direction of travel of the mower; for example, vertical, or an obtuse angle such as 110 degrees.

The acute angle may be between 45 degrees and 85 degrees measured from the longitudinal axis of the side channel, or otherwise the direction of travel of the mower. For example, this angle may be between 65 degrees and 75 degrees from the direction of travel of the mower, for example 70 degrees.

### Deck Height Gauge

Also shown in FIG. 2A, is an example of a height gauge 124 which can be used to visually determine the height setting of the deck. In use the height gauge 124 passes through a channel or slot 204 in the side channel 108, the dimensions of this slot relate to the horizontal travel (or travel in the longitudinal direction of the side channel) of the height gauge relative to the side channel.

The height gauge 124 is provided with a series of graduated measurements 206 which allows the position of the deck 102 relative to the side channel 108 to be easily determined by looking at the graduated measurement which most closely aligns with the upper edge 126 of the side channel.

It will be appreciated by those skilled in the art that other methods of providing a height gauge 124 are envisaged as being within the scope of the present technology. For example, as the support structure 104/side channels 108 is/are configured to move relative to the deck 102 the deck may comprise a series of height indicators which are covered or revealed as the height is adjusted.

It should also be appreciated that the deck height gauge 124 may be used in combination with or independently from any one or more of the deck height adjustment systems described herein.

### Cam Height Adjustment Systems

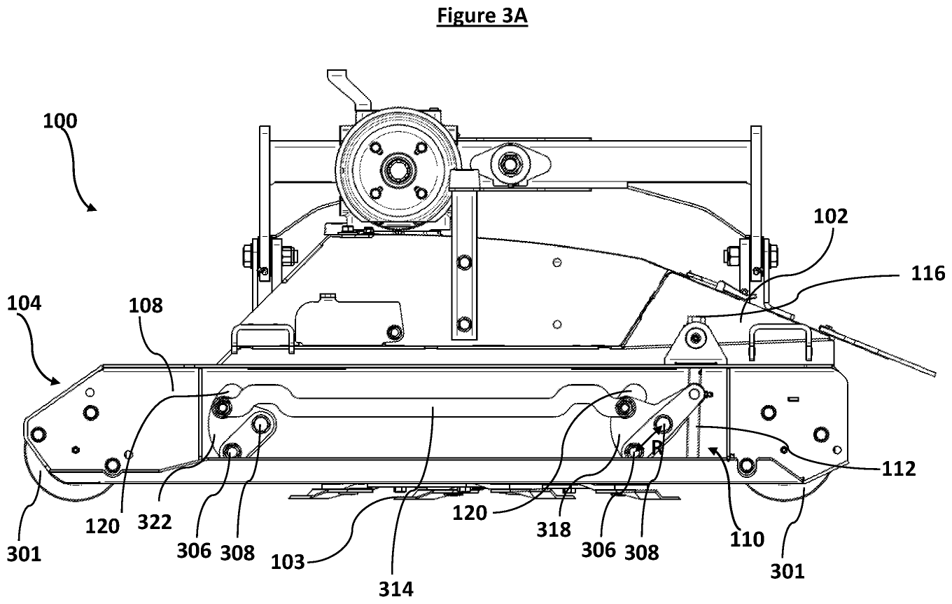

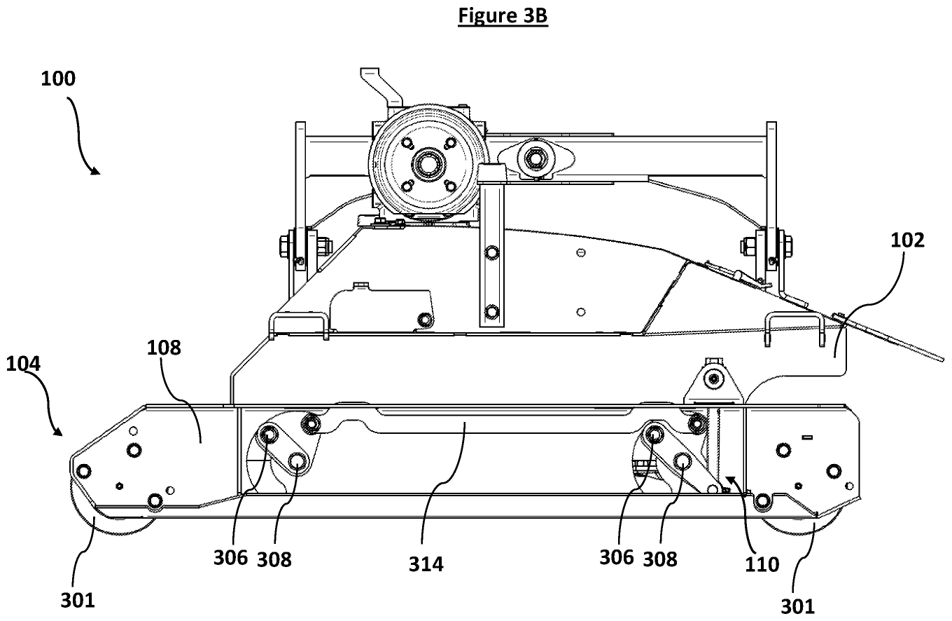

FIGS. 3A and 3B show a mower 100 which includes an alternative cutting height adjustment mechanism 110 according to one embodiment of the present technology. This embodiment has been illustrated without a skid for purposes of clarity only, allowing the cutting system 103 and wheels or rollers 301 to be clearly seen.

As in previous embodiments, the mower 100 includes a deck 102 and a support structure 104 which includes side channels 108. The adjustment mechanism includes a deck adjustment mechanism 110 which comprises a threaded actuator 112, which is configured to act upon a first cam 318. The first cam is rotatably connected at its pivot point 308 to the side channel 108 and to the deck 102 of the mower 100 at a radial distance ‘R’ from the pivot point using a drive pin or fastener 306. In the pictured embodiment, a second cam 322 is also provided with the same connection arrangement. A link arm 314 is attached therebetween.

The link arm 314 transfers rotational movement from the first cam 318 to the second cam 322 to ensure that each end of the side channels/deck move synchronously with each other, and preferably through translational movement, i.e. both ends of the deck/side channels move simultaneously between the height positions. By moving both ends of the side channel 108 simultaneously, or in unison, the deck/side channel 108 is maintained in the same orientation as it is moved between the first position shown in FIG. 3A, to the second position of FIG. 3B, thereby ensuring an even cut.

Again, it will be appreciated with reference to the present disclosure that there is a continuous non-discrete number of adjustment heights achieved by the present technology.

As the deck 102 moves relative to the support structure 104, it travels through an arcuate path which matches the shape of the corresponding apertures 120, and positioning of the drive pin or fastener 306 relative to the pivot point 308. Having an adjustment mechanism which moves the support structure 104/side channel 108/deck 102 through an arcuate path may allow for greater adjustability of the height of the support structure relative to the deck. In addition, this may provide similar advantages to the angled adjustment mechanism illustrated in FIG. 1.

It should be appreciated that the foregoing is described in relation to a first side of a support structure and any one or more of the adjustment mechanisms described herein may be provided to any other side of the support structure.

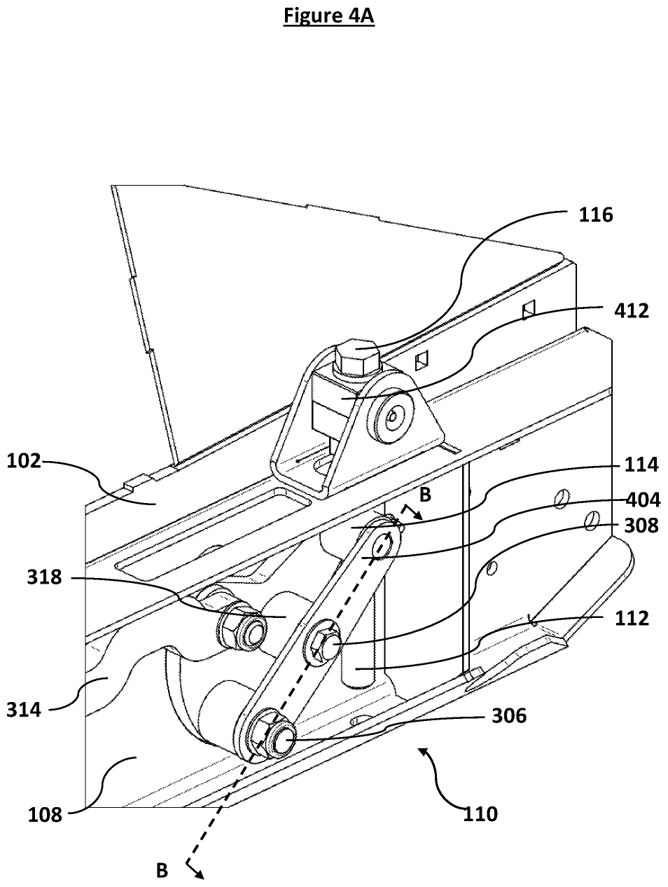

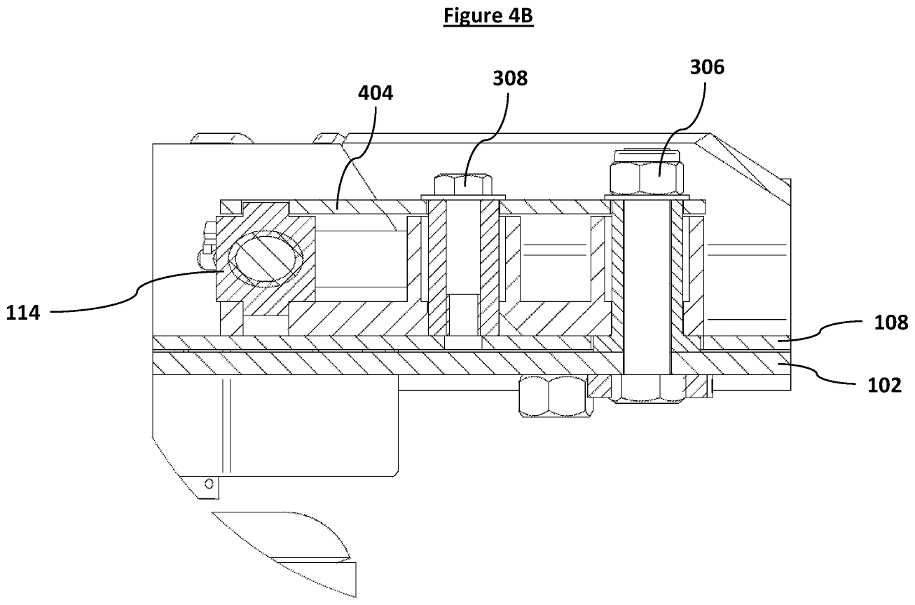

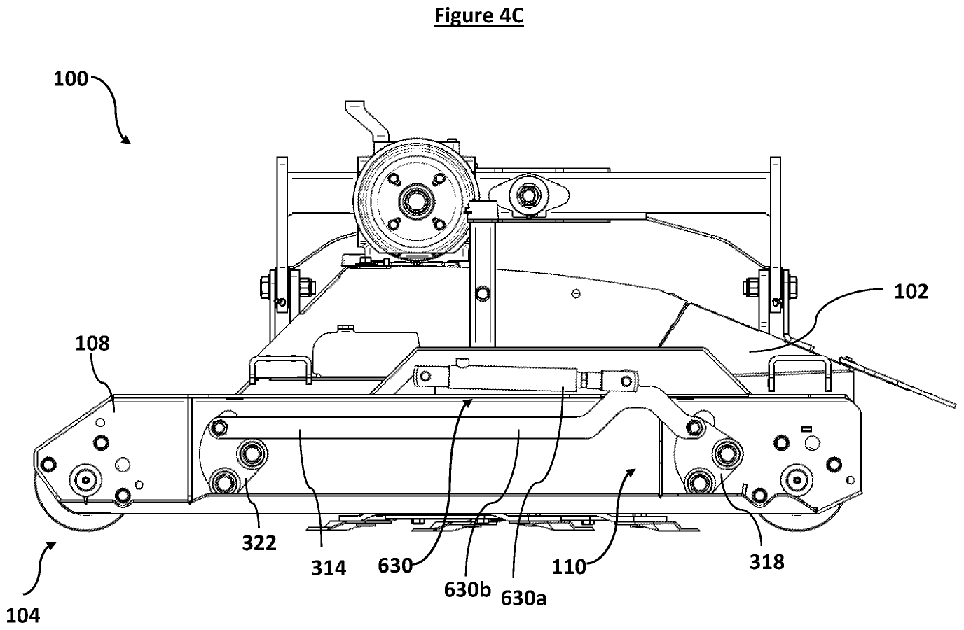

FIGS. 4A to 4C provide close-up and cross-sectional views of the adjustment mechanism 110 of the embodiment of FIGS. 3A and 3B. In these embodiments, a threaded aperture (not pictured) in the adjuster block 114 transfers the rotational movement of the threaded actuator 112 into pivotal movement of the cam 318 about the pivot point 308. The adjuster block 114 is pivotally connected to the cam to allow for angular changes as the cam rotates through its range of motion, for example using the mounting block 412.

The adjustment mechanism 110 further includes a support plate 404 which is clamped in place using the drive pin or fastener 306 and pivot fastener about the pivot point 308. This support plate may assist in transferring the rotational forces provided by the threaded actuator 112 into the aforementioned pivotal movement.

The drive pin or fastener 306 attaches the deck 102 to the cam 318, while the mount pin may be fixedly attached to the side channel 108, for example by welding or a similar process.

An aperture 120 has been provided with an arcuate shape, the radius of which preferably matches the radius of the cam 318. This further acts as a guide for the cam 318 and may serve to limit its range of motion.

An optional wear plate (not pictured) may be positioned between the side channel 108 and the deck 102 and may be made of a durable abrasion resistant material such as a metal or polymer.

FIG. 4B provides a close-up view of the top of the threaded actuator 112 including the adjustment head 116. The top of the threaded actuator is retained by a mounting block 412 which is mounted in a U-shaped bracket 514. The mounting block is pivotally mounted within the U-shaped bracket so that it may rotate to account for movement of the cam during use. The U-shaped bracket is preferably attached to the side channel, for example, by using fasteners or welding.

It should be appreciated that in the foregoing examples, the adjustment mechanism 110 comprises a threaded actuator by way of example only. For example, FIG. 4C shows one example of the technology in which a pneumatic or hydraulic ram provides the height adjustment control. For example, the ram can be configured to act upon any one of the cams 318, 322, or the link arm 314, as shown in FIG. 4C.

### Geared Adjustment Mechanism

FIGS. 5A to 5E show a further embodiment of the technology, in which the height adjustment mechanism is 110 is provided by a drive means 109 such as an electric motor. FIG. 5A shows a perspective view of a support structure 104 comprising a pair of side channels 108 and front and rear rollers 301 extending between the side channels 108. For sake of clarity the deck has not been shown.

In the illustrated example, the side channel includes a side cover 502, which has been removed in FIG. 5F to show one example of a height adjustment mechanism 110. In this example the side channel is provided with a drive means 109 which is connected to a series of rotating elements in the form of gears which transfer rotational torque from the motor through to a first cam 318 and a second cam 322. In the illustrated example the cams 318, 322 are connected to one of the rotating elements such that, as the rotating elements rotate, the drive pin or fastener 306 rotates. The drive pin 306, like in the previous embodiments of the technology, connects the deck 102 to the cams such that rotation of the cams, causes the deck to travel through an arcuate path corresponding to the path of the drive pin 306. The offset of the drive pin from the centre of the cam defines the radius of the arcuate path through which the drive pin 306 and attached deck 102 travels in use.

As the cams are configured to rotate relative to the side channel, it may be beneficial for each cam to include a bearing to reduce wear on other components of the side channel, and to ensure that the centre point of the cams remains substantially fixed in use. For example, each cam may include a bearing surface between the side channel and the respective cam, which the respective cam bears on in use. In other examples each cam may be provided with a ball bearing wherein the outer race of the ball bearing is attached to the side channel, and the inner race of the ball bearing is attached to the cam.

In the illustrated examples the rotating elements comprise a series of gears 504 which constitute a gear assembly. However, this should not be seen as limiting on the technology, and the rotating elements may instead comprise other known rotating components, including chain and belt drive systems. In some examples the rotating elements may include a combination of any one or more of gears, belts, chains, link arms or any other appropriate mechanism for transferring movement from the drive means 109.

Similarly, while the drive means 109 is illustrated as a motor, such as an electric motor, this also should not be seen as limiting, for example a rack and pinion system may be used to convert linear movement, such as from a pneumatic or hydraulic cylinder, to rotational motion, as should be familiar to those skilled in the art. In other examples as described herein the drive means may comprise a connector configured to engage with a power take-off (PTO) on a tractor or prime mover. As has already been mentioned, in other examples, the drive means 109 may comprise a battery.

In the example illustrated the rotating elements constitute a gear assembly. The gear assembly may provide a reduction between the drive means and the cams, for example with a relatively high gear ratio. In the illustrated example the gear assembly may be provided with a total gear ratio of approximately 1 to 30. For example, the gear assembly may comprise a first gear 504A with approximately 12 teeth, which engages with a second gear 504B with approximately 50 teeth to provide a gear ratio of approximately (12:50) or (6:25). The second gear 504B is coaxial (to form a compound gear) with a third gear 504C comprising 22 teeth, the third gear 504C engaging with a fourth gear 504D comprising approximately 56 teeth for third-to-fourth gear ratio of (22:56) or (11:28) thereby providing a first-to-fourth gear ratio of (33:350). The fourth gear 504D being coaxial (to form a compound gear) with a fifth gear comprising 18 teeth. In the illustrated example the fifth gear 504E engages with a pair of opposing but equally sized sixth gears 505F comprising 44 teeth each which in turn are connected to drive (seventh) gears 505G comprising 52 teeth each. The fourth-to-fifth ratio is therefore approximately (9:26) for an overall first-to-eighth ratio of (297:9100) or approximately (3:91) or approximately (1:30).

In the illustrated example each of the gears 504 are oriented substantially vertically within the side channels, such that the axis of rotation of each of the gears is substantially horizontal, or parallel with the ground. This orientation may advantageously allow for a more compact or narrow side channel such as a side channel having a width of less than approximately 100 mm or more preferably less than approximately 60 mm. Narrow side channels can be advantageous in reducing the total size and weight of the mower, as well as reducing the amount of non-cutting area which can compress the vegetation as the mower moves across the ground. Additionally, this means that the total width of the mower can more closely match the total width of the cut, making it easier for an operator to align the mower with previous cuts, reducing the total number of passes required, and reducing the likelihood that vegetation is missed.

In the illustrated example, the first gear 504A is attached to the drive means 109 and may be attached by any suitable connection mechanism known to those skilled in the art including a direct connection, a clutch connection, using a gearbox or bevelled gears. In some examples it may be advantageous to use a worm gearbox, such that in the event of power failure, the deck is maintained at a constant height and does not fall under gravity.

In the illustrated example, the first gear 504A is positioned centrally to the gear assembly, in a topmost position. Below the first gear, such as substantially directly vertically below, the first gear meshes with the second gear 504B. The second 504B and third gears 504C provide a compound gear in which the third gear is positioned more inwardly towards the cutting deck than the second gear. Below the compound second and third gears, such as substantially directly below, the third gear meshes with the fourth gear. The fourth and fifth gears provide a compound gear in which the fourth gear is positioned more inwardly towards the cutting deck than the fifth gear. In this example the first, second, third, fourth and fifth gears are aligned substantially on a common axis.

The fifth gear meshes with two opposing sixth gears, aligned in a substantially horizontal axis, or otherwise, in an axis which is substantially parallel with the ground in use. Each of the sixth gears mesh with corresponding seventh gears along the same substantially horizontal axis in opposing directions. It should be appreciated that in the illustrated example the seventh gears turn in substantially the same direction. However, this should not be seen as limiting for example, in an alternative example one of the sixth gears may be omitted, such that the cams on opposing ends of the gear assembly turn in opposite directions. In this example the drive pins may be offset such that, despite the cams rotating in different directions, the cams both rise and fall synchronously with one another to ensure that the cut height remains substantially parallel with the ground.

Accordingly, the first, second, fifth, sixth and seventh gears are located on a first plane within the side channels, while the third, and fourth gears are on a second plane which is offset in a horizontal axis from the first plane.

One potential advantage of having a high gear ratio such as approximately 1:30 is that a high mechanical advantage can be provided, while providing fine granular control of the deck 102 positioning relative to the side channels 108. Further benefits of using a compound gear arrangement can include the ability to obtain a high gear ratio may without requiring large gear size differences between the first gear and the drive gear.

The use of rotating means also potentially has advantages in space constrained situations such as within the side channels, where it can be desirable for the side channel to be as narrow as possible as described above. The use of gears can advantageously be less prone to slipping, fraying, or breaking when compared to belt or chain drive systems.

It should also be appreciated that, in some examples, each side of the support structure may include independently controllable drive means 109, for example to allow for side-to-side height adjustment, while in other examples, the drive means on each side of the support structure may be linked to ensure that the height adjustment mechanism allows for even side-to-side adjustment. For example, a control circuit may be provided for the drive means, which sends equivalent control signals to each motor to ensure that they operate in unison. In other examples a single drive means 109 may be provided which is mechanically connected to the rotating elements on each side of the support structure, such that rotation of the drive means causes rotation of the rotating elements on both sides simultaneously. In some examples, the drive means 109, or each drive means 109, may be configured to be wirelessly controlled through a wireless communication link. For example, a central controller may be configured to send control signals over a wireless communication link to the or each drive means 109. Wireless communication between each drive means 109 and the central controller may be useful for avoiding, or reducing, the amount of cabling necessary. The central controller may be comprised as part of, or linked to, a user control unit having a user interface with which a user can interact. The user control unit may be located in a cab of a vehicle or may be a mobile communication device, for example a smartphone, tablet or computer.

### Fixed Roller Spacing

In each of the foregoing examples, the wheels or rollers 301 are fixed to the side structure such that during height adjustment the spacing of the wheels or rollers 301 relative to one another remain substantially fixed. In other words, the present technology provides height adjustment systems which are configured to move the deck of a mower relative to the support structure comprising wheels or rollers, without changing the spacing between the wheels or rollers, or otherwise maintaining a consistent spacing between the wheels or rollers.

In another example the present technology provides height adjustment systems configured to allow for the positioning of the deck of a mower to be adjusted relative to the support structure, the support structure comprising rollers which are rotationally fixed between a first side channel and a second side channel.

Wheel and roller positioning can be important as:
The front facing roller should ideally be positioned sufficiently forward of the cutting elements such that the grass or vegetation has an opportunity to spring back up in time to be cut by the cutting elements.
The real roller or wheels should ideally be close to the cutting elements such as within 10-30 mm of the cutting elements. Positioning the rear roller or wheels adjacent to the cutting elements can advantageously assist with the discharge and/or spreading of cut vegetation from the mower, as the grass can be directed up and over the rear roller.

Accordingly, the relative positioning of the front and rear rollers relative to the cutting elements can be an important design consideration, and accordingly, it can be important that this relative positioning is maintained during cutting height adjustment.

The examples described earlier maintain a constant spacing between the at least one front roller and the at least one rear roller while the height adjustment mechanism moves the mowing deck between raised and lowered positions. This may be achieved by the mechanism moving the mowing deck 102 as a whole relative to the support structure 104 without altering the configuration of the support structure 104, and thereby without altering the spacing between the rollers. Different examples of heigh adjustment mechanisms that achieve this are described above.

### Variations to the Technology

In each of the foregoing examples, the height adjustment mechanisms have primarily been described in relation to adjusting a single side of a mower deck relative to a single side channel. It should be appreciated, that any one or more of the height adjustment mechanisms may be provided to one or more sides of the deck, and in the case of a multi-deck mower (a mower comprising multiple independent decks) any one or more of the decks.

For example, in the embodiments of the technology where a threaded actuator is used, it should be appreciated that a threaded actuator may be provided to each side of the support structure to facilitate adjustment of both sides of the deck relative to the support structure. Alternatively, a single adjustment mechanism may be operatively connected to both sides of the support structure to facilitate adjustment of both sides of the mower deck simultaneously.

In some examples, the first side of the mower deck may be operatively connected to the second side of the deck. For example, in the embodiments of the technology comprising cams, the cams may be linked using a mechanical linkage, a hydraulic or pneumatic circuit, or an electronic control system. In embodiments where a hydraulic or pneumatic linkage is provided, it should be appreciated that a first ram may be provided to a first side channel which is fluidly connected in parallel with a second ram on the second side channel, such that increases in pressure within the circuit result in equal forces being provided to both rams. Similarly in electronic control systems, methods of synchronising the operation of height adjustment systems on opposing sides of the support structure should be familiar to those skilled in the art. As has been stated, in some forms, wireless communication occurs between in a drive unit on each mower deck and a central controller.

One example of the technology provides a mower attachment for a prime mover, the mower attachment comprising one or more decks, each of the one or more decks being supported at a height above the ground by one or more support structures. In preferred examples the support structures each comprise a plurality of side channels, positioned at opposing lateral sides of the decks, and oriented substantially in parallel with one another, and the direction of travel of the mower attachment in use. Each of the support structures preferably includes a deck height adjustment system which is configured to raise or lower the height of the one or more decks with respect to the support structures, and one or more rollers. In preferred examples the deck height adjustment system is configured to raise or lower the height of the one or more decks while maintaining the one or more rollers in a substantially fixed position relative to the supporting structure.

### Multi-Deck Mower

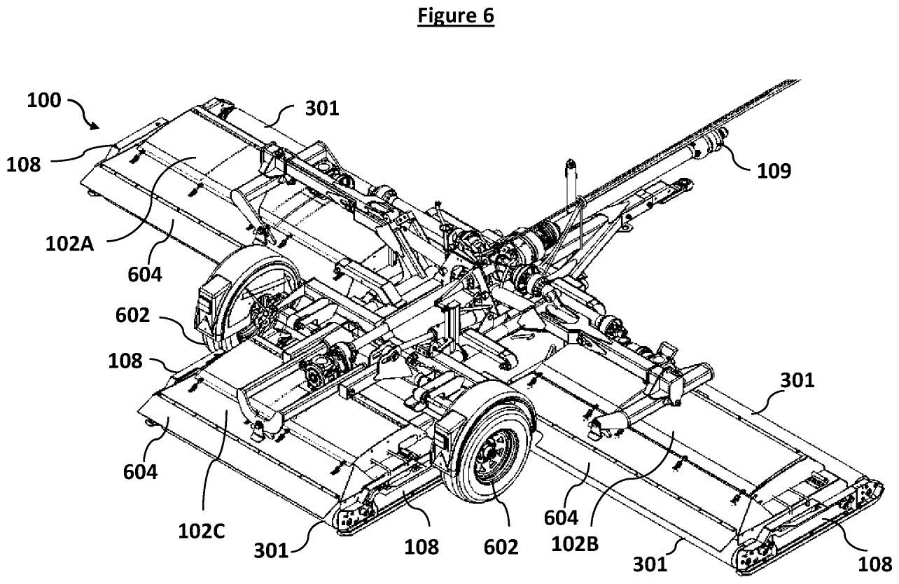

FIG. 6 shows a multi-deck commercial mower 100 comprising more than one mowing deck 102A, 102B, 102C. Each deck is supported at a height above the ground by a support structure 104A, 104B, 104C comprising side channels 108 including front and rear rollers 301 and a cutting height adjustment mechanism 110 (not pictured but as described herein). Preferably, each deck includes the same cutting height adjustment mechanism as the other deck(s). However, it is also envisaged that each deck may have a different cutting height adjustment mechanism to the other deck(s).

In the example of FIG. 6, the mower 100 comprises three decks, however this should not be seen as limiting. In addition, the drive means 109 in this example is a connector to a power take off (PTO) from a prime mover, which should not be seen as limiting and any suitable drive means may be used. For example, in another example, the drive means 109 may comprise one or more batteries. The batteries may be rechargeable from the vehicle motor.

FIG. 6 also illustrates a number of optional components not present in the other figures, but each of which may be used in any one of the embodiments described herein, including:
Wheels 602 configured to help bear the weight of the mower, particularly when the first deck 102A and second deck 102B are stowed in a substantially vertical orientation during transportation; and
Flaps 604 configured to divert the flow of discharged vegetation downwardly towards the ground in use.

In examples where each deck has a different cutting height adjustment mechanism to the other deck(s), each deck has a separate drive means 109 to the other deck(s). As explained earlier, these drive means 109 may be controllable over a wireless communication link. In some examples a central controller may be configured to send control signals to each drive means 109. Each drive means 109 may also be configured to send status signals back to the central controller so that the central controller knows at what height each deck is at and can send suitable control signals accordingly. The central controller may be comprised as part of, or linked to, a user control unit having a user interface with which a user can interact. The user control unit may be in a cab of a vehicle or may be a mobile communication device, for example a smartphone, tablet or computer.

### Other Remarks

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. A mower comprising:
a mowing deck which comprises cutting elements configured to cut plant material, and a housing which contains the cutting elements; and
a support structure configured to support the mowing deck at a height above a surface, wherein the support structure comprises a first side channel positioned on a first side of the mowing deck, and a second side channel positioned on a second side of the mowing deck, such that the mowing deck is positioned between the first and second side channels,
wherein the support structure comprises a height adjustment mechanism configured to allow for the adjustment of the height of the mowing deck relative to the surface, by moving the mowing deck relative to the side channels, and
wherein the height adjustment mechanism comprises at least one cam in each side channel, wherein the cams are configured to act on the mowing deck to move the mowing deck relative to the side channels.

2. A mower as claimed in claim 1, wherein the orientation of the mowing deck with respect to the support structure remains substantially constant as the height adjustment system changes the height of the mowing deck with respect to the surface.

3. A mower as claimed in claim 1, wherein the first side channel is substantially parallel to the second side channel.

4. A mower as claimed in claim 1, wherein the first side channel and second side channel comprise a series of rotating elements configured to transfer rotational movement from a drive means to the at least one cam.

5. A mower as claimed in claim 4, wherein the series of rotating elements comprises a gear assembly which comprises a plurality of gears.

6. A mower as claimed in claim 5, wherein the gear assembly is configured to provide a gear ratio of between substantially 1:20 and 1:40 such as substantially 1:30.

7. A mower as claimed in claim 5, wherein the gear assembly comprises a plurality of gears oriented with an axis of rotation which is substantially horizontal, or substantially parallel to the surface or ground.

8. A mower as claimed in claim 1, wherein the height adjustment mechanism is configured to move the mowing deck through an arcuate path of movement between a raised position and a lowered position.

9. A mower as claimed in claim 1, wherein the height adjustment mechanism is configured to move the mowing deck through a substantially linear path of movement between a raised position and a lowered position.

10. (canceled)

11. (canceled)

12. A mower as claimed in claim 1, wherein the mower comprises at least one front roller and at least one rear roller, the at least one front roller being positioned between the first side channel and the second side channel substantially on a front side of the support structure, and the at least one rear roller being positioned between the first side channel and the second side channel substantially on a rear side of the support structure.

13. A mower as claimed in claim 12, wherein the height adjustment mechanism is configured to adjust the height of the mowing deck relative to the support structure while maintaining a constant distance between the at least one front roller and the at least one rear roller

14. A mower comprising:
a mowing deck which comprises cutting elements configured to cut plant material, and a housing configured to contain the cutting elements;
a support structure configured to support the mowing deck at a height above a surface; and
a height adjustment system,
wherein the support structure comprises a first side channel positioned on a first side of the mowing deck, and a second side channel positioned on a second side of the mowing deck, such that the mowing deck is positioned between the first and second side channels, and
wherein the height adjustment system comprises a drive means configured to provide a rotational force, and wherein the first side channel and/or second side channel comprise a series of rotating elements configured to transfer rotational movement from the drive means to at least one cam, the at least one cam being rotatably connected to the first side channel and/or second side channel, and operatively connected to the mowing deck, such that rotation of the cam causes the height of the mowing deck to change.

15. A mower comprising:
a mowing deck which comprises cutting elements configured to cut plant material, and a housing configured to contain the cutting elements; and
a support structure configured to support the mowing deck at a height above a surface,
wherein the support structure comprises a first side channel positioned on a first side of the mowing deck, a second side channel positioned on a second side of the mowing deck, such that the mowing deck is positioned between the first and second side channels, and at least one front roller, and at least one rear roller, the at least one front roller being positioned between the first side channel and the second side channel substantially on a front side of the support structure, and the at least one rear roller being positioned between the first side channel and the second side channel substantially on a rear side of the support structure, and
wherein the support structure comprises a height adjustment mechanism configured to adjust the height of the mowing deck relative to the support structure while maintaining a constant distance between the at least one front roller and the at least one rear roller.

16. A mower as claimed in claim 15, wherein the orientation of the mowing deck with respect to the support structure remains substantially constant as the height adjustment system changes the height of the mowing deck with respect to the surface.

17. A mower as claimed in claim 15, wherein the side channels are positioned at opposing sides of the mowing deck, substantially parallel to each other.

18. A mower as claimed in claim 15, wherein each of the plurality of side channels comprises a series of rotating elements configured to transfer rotational movement from a drive means to at least one cam, wherein each of the cams is configured to act on the mowing deck to move the mowing deck relative to the side channels.

19. A mower as claimed in claim 18, wherein the series of rotating elements comprises a gear assembly which comprises a plurality of gears.

20. (canceled)

21. A mower as claimed in claim 19, wherein the gear assembly comprises a plurality of gears oriented with an axis of rotation which is substantially horizontal, or substantially parallel to the surface or ground.

22. A mower as claimed in claim 15, wherein the height adjustment mechanism is configured to move the mowing deck through an arcuate path of movement between a raised position and a lowered position.

23. A mower as claimed in claim 15, wherein the height adjustment mechanism is configured to move the mowing deck through a substantially linear path of movement between a raised position and a lowered position.

24. (canceled)

25. (canceled)
